(19) United States
(12) Patent Application Publication
(10) Pub. No.: US 2004/0163016 A1
(43) Pub. Date: Aug. 19, 2004

(54) Method and apparatus for supporting error cause of SNMP

(76) Inventor: Jun-Seog Kim, Suwon-city (KR)

Correspondence Address: Robert E. Bushnell, Suite 300, 1522 K Street, N. W., Washington, DC, 20005, US

(21) Appl. No.: 10/773,335

(22) Filed: Feb. 9, 2004

(30) Foreign Application Priority Data
Feb. 14, 2003 (KR) 2003-9518

(51) Int. Cl. H02H 3/05

(52) U.S. Cl. 714/47

(57) ABSTRACT

A method and an apparatus for supporting error cause of network management system are for exchanging an error cause defined by a different standard between a manager and an agent, especially when a present error status cannot be defined by error causes defined by SNMP (Simple Network Management Protocol) standard. The SNMP agent receives an SNMP message from the manager under Get/SetRequest command, and analyzes the received SNMP message to compare and find out whether or not a normal execution is possible. If it turns out that the normal execution is possible, the SNMP agent executes an internal command, and transmits a response message thereof to the manager. However, if it turns out that the SNMP message is abnormal, the SNMP agent first compares and finds out whether the abnormal SNMP message can be represented by one of SNMP standard error causes. If the SNMP message can be represented by the SNMP standard error cause, the response message based on the SNMP standard error causes is transmitted to the manager. On the other hand, if it is impossible to express the SNMP message to the SNMP standard error cause, the SNMP agent transmits the response message using different standard error causes (TL1). Hence, the present invention can be advantageously used for preventing error occurrence for the second, third time due to ambiguous error causes, by expressing a status of an SNMP agent more accurately than the 20 error causes defined by SNMP V1/V2/V3.

### CLAIM OF PRIORITY

This application makes reference to, incorporates the same herein, and claims all benefits accruing under 35 U.S.C. § 119 from an application entitled METHOD FOR SUPPORTING ERROR CAUSE OF SNMP AND APPARATUS THEREOF earlier filed in the Korean Intellectual Property Office on 14 Feb. 2003 and thereby duly assigned Serial No. 2003-9518.

### BACKGROUND OF INVENTION

1. Field of the Invention

The present invention generally relates to a method and an apparatus for exchanging an error message between an SNMP manager and an SNMP agent using SNMP (Simple Network Management Protocol) V1/V2/V3 protocol. More particularly, the present invention relates to a method and an apparatus for supporting error cause of SNMP, capable of exchanging error cause defined based on different standards between the manager and the agent, when it is impossible to express a present error status using the error cause defined by the SNMP standard.

2. Description of Related Art

In recent years, most network-related equipments including the Internet have been using a network management protocol based on an SNMP (Simple Network Management Protocol), to manage network and monitor operations of respective network devices. The SNMP is the most typical network management protocol, and through which, an SNMP manager and an SNMP agent can exchange data.

There are only 20 error cause messages defined by the SNMP standard. If the manager makes a request to the agent, the agent gives a response when the request is normal. However, if the request is abnormal or if a corresponding command cannot be executed, it is very difficult to express an error status more accurately.

In other words, the certain set of error cause messages are the only ones the SNMP standard of the related art provides. Therefore, if a present error cause is not listed in the 20 error messages defined by the SNMP standard, it is very difficult to express the present error status.

In such case, the manager cannot receive a more accurate error cause message from the agent, and performs a next operation based on an inaccurate error cause message, only causing a second, third unexpected errors.

### SUMMARY OF THE INVENTION

An object of the invention is to solve at least the above problems and/or disadvantages and to provide at least the advantages described hereinafter.

Accordingly, one object of the present invention is to solve the foregoing problems by providing a method and an apparatus for supporting error cause of SNMP, wherein a manager transmits a request message to an agent, and if it is impossible for the agent to execute the message normally, the agent provides a more accurate error cause from more extended standard error cause messages, thereby facilitating network management.

It is another object of the present invention to be advantageously used for preventing error occurrence for the second, third time due to ambiguous error causes, by expressing a status of an SNMP agent more accurately than 20 error causes defined by SNMP V1/V2/V3, where in this manner, when an operator does network management, a great amount of time is saved.

It is yet another object to provide the use of error cause categories of a different standard, it is possible to integrate different error causes by project, applying to the development of an SNMP agent for other equipment later on, and it can be a new standard for defining a SNMP error cause.

It is still another object to provide an apparatus for supporting error cause of SNMP that is more efficient, easier to implement, and more cost effective.

The foregoing and other objects and advantages are realized by providing a method for supporting error cause of network management system configured by an SNMP (Simple Network Management Protocol) manager and a SNMP agent, the method including: if an error which is not defined in SNMP error causes is occurred, selecting a standard error cause management interface to be used; numbering an error cause defined by the selected interface; storing the numbered error cause in a database of the SNMP manger database and a database of the SNMP agent, respectively; and when standard error cause is databased, actually exchanging a message between the SNMP manager and the SNMP agent, and conducting a network management operation.

Preferably, the step for exchanging the message between the SNMP manager and the SNMP agent and conducting the network management operation includes: receiving, at the SNMP agent, an SNMP message from the SNMP manager under Get/SetRequest command; comparing and deciding, at the SNMP agent, whether a normal operation on the SNMP message is possible by analyzing the received SNMP message; if the normal operation can be performed, executing, at the SNMP agent, an internal command, and transmitting a response message thereof to the SNMP manager; if the SNMP message is abnormal, comparing and deciding, at the SNMP agent, whether the SNMP message can be represented by a SNMP standard error cause; if the SNMP message can be represented by the SNMP standard error cause, transmitting, at the SNMP agent, the SNMP manager a response message defined by the SNMP standard error causes; and if the SNMP message cannot be represented by the SNMP standard error cause, transmitting, at the SNMP agent, the SNMP manager a response message based on a different error cause.

Another aspect of the present invention provides an apparatus for supporting error cause of network management system configured of an SNMP (Simple Network Management Protocol) manager and a SNMP agent, the apparatus including: a SNMP manager mounted with a database for providing SNMP standard error causes and a database for providing extended standard error causes besides the SNMP standard error causes by using a different protocol, and an error analysis application for analyzing an extended standard error cause; and an SNMP agent mounted with a database for providing SNMP standard error causes and a database for providing extended standard error causes besides the SNMP standard error causes by using a different protocol, and an error search application for searching an error cause number in case an error cause corresponding to a present error status is found in the extended standard error causes, and recording the error cause number in an Err-Status field of a SNMP PDU (Protocol Data Unit).

### BRIEF DESCRIPTION OF THE DRAWINGS

A more complete appreciation of the invention, and many of the attendant advantage thereof, will be readily apparent as the same becomes better understood by reference to the following detailed description when considered in conjunction with the accompanying drawings in which like reference symbols indicate the same or similar components, wherein:

FIG. 1 is a diagram depicting a message exchange of an SNMP (Simple Network Management Protocol) according to the present invention;

FIG. 2 is a diagram illustrating a SNMP message format according to the present invention;

FIG. 3 is a flow chart describing a message transmitting and receiving in a network management system to which an SNMP of the related art is applied;

FIG. 4 is a flow chart describing a method for supporting error cause of network management system using SNMP according to a preferred embodiment of the present invention;

FIG. 5 shows an example of a computer including a computer-readable medium having computer-executable instructions for performing a technique of the present invention.

### DETAILED DESCRIPTION OF EXEMPLARY EMBODIMENTS

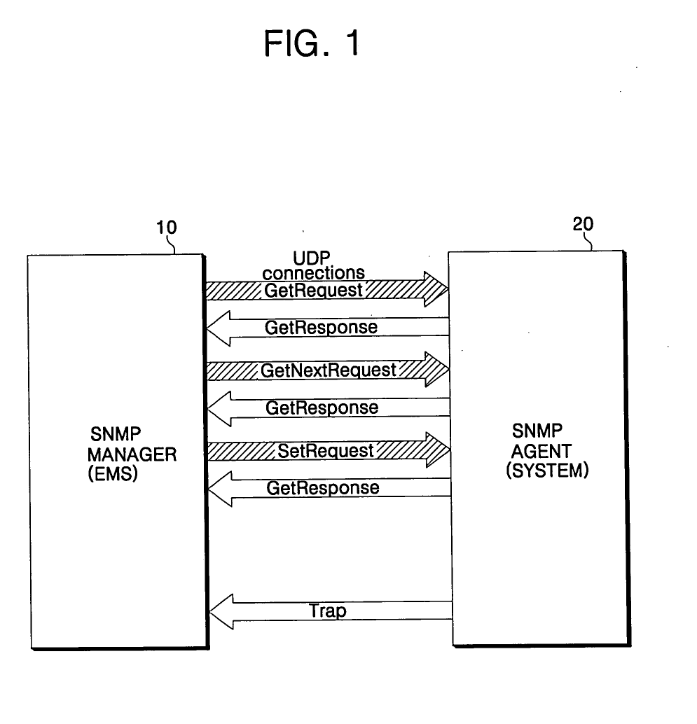

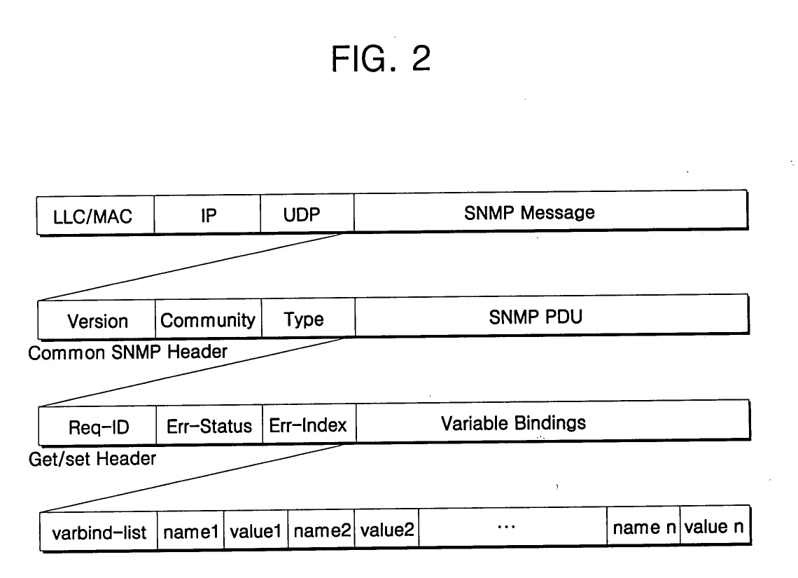

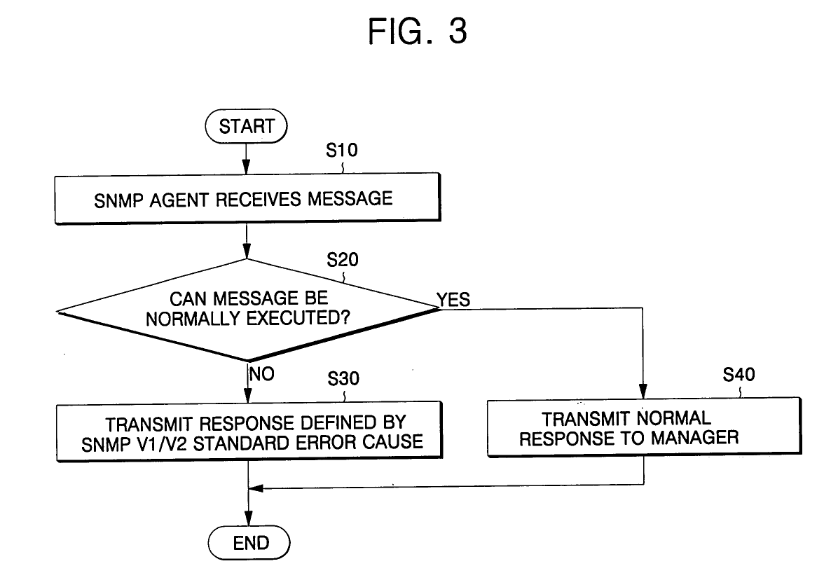

Turning now to the drawings, FIG. 1 is a diagram depicting a message exchange of an SNMP according to the present invention, and FIG. 2 is a diagram illustrating an SNMP message format according to the present invention, and FIG. 3 is a flow chart describing a message transmitting and receiving in a network management system to which an SNMP of the related art is applied.

Referring to FIGS. 1 through 3, when an SNMP manager 10 transmits a request to an SNMP agent 20, the SNMP agent 20 receives the request message (S10), and compares/decides whether or not the received message can be executed normally (S20). If the SNMP agent 20 can respond to the request, the SNMP agent 20 transmits a corresponding response to the SNMP manager 10 (S40).

On the other hand, if the request message turns out to be an abnormal message in step 20, the SNMP agent 20 transmits the SNMP managers 10 the response as SNMP V1/V2/V3 standard error cause (S30).

As illustrated in FIG. 2, the standard error cause is numbered in an Err-Status field in an SNMP PDU (Protocol Data Unit).

More details on SNMP messages transmitted and received to/from the SNMP manager 10 and the SNMP agent 20 are now explained.

The following are commands that are transmitted and received to/from the SNMP manager 10 and the SNMP agent 20 shown in FIG. 1.

GetRequest: A request signal for reading an object

GetNextRequest: A request signal for reading a next object after a present object

GetResponse: A response signal for a request

SetRequest: A signal for writing an object value

Trap: Exceptional status information

Each field in the SNMP message format shown in FIG. 2 is now explained.

LLC/MAC field: Logical Link Control/Media Access Control address

IP field: IP (Internet Protocol) address

UDP (User Datagram Protocol): A port number being used

version: SNMP version

Community: Particulars in password system defined between a manager and an agent

Type: Kind of a message (e.g. ‘0’ is GetRequest.)

Req-ID: This is set up by a manager, and an agent returns an equivalent value to GetResponse.

Err-Status: ‘0’ denotes a normal status, and other numbers besides ‘0’ denote error causes.

Variable Bindings: Diverse bindings for variables (object ID)

Among others, the Err-Status (error status) will be explained in more detail.

Standard error cause messages defined in SNMP V1/V2/V3 standard are illustrated in Table 1.

TABLE 1

| Error status | Variable |
|---|---|
| #define NO_ERROR | 0 |
| #define TOO_BIG | 1 |
| #define NO_SUCH_NAME | 2 |
| #define BAD_VALUE | 3 |
| #define READ_ONLY | 4 |
| #define GEN_ERR | 5 |
| #define NO_ACCESS | 6 |
| #define WRONG_TYPE | 7 |
| #define WRONG_LENGTH | 8 |
| #define WRONG_ENCODING | 9 |
| #define WRONG_VALUE | 10 |
| #define NO_CREATION | 11 |
| #define INCONSISTENT_VALUE | 12 |
| #define RESOURCE_UNVAILABLE | 13 |
| #define COMMIT_FAILED | 14 |
| #define UNDO_FAILED | 15 |
| #define AUTHORIZATION_ERROR | 16 |
| #define NOT_WRITABLE | 17 |
| #define INCONSISTENT_NAME | 18 |
| #define LAST_ERROR | 19 |

As shown above, there are 20 kinds of error cause messages defined by the SNMP standard. If the manager makes a request to the agent, the agent gives a response when the request is normal. However, if the request is abnormal or if a corresponding command cannot be executed, it is very difficult to express an error status more accurately.

In other words, the above error cause messages in Table 1 are only ones that the SNMP standard of the related art provides. Therefore, if a present error cause is not listed in the Table 1, it is very difficult to express the present error status.

In such case, the manager cannot receive a more accurate error cause message from the agent, and performs a next operation based on an inaccurate error cause message, only causing a second, third unexpected errors.

Reference will now be made in detail to exemplary embodiments of the present invention, which are illustrated in the accompanying drawings.

To begin with, TL1 error cause (Transaction Language 1) is explained.

1 TL1 is an equipment maintenance/management protocol defined by an American company, BELLCORE (currently, TELECORDIA), back in the early 1980's. It is a message transfer system between OS (Operations System) and NE (Network Element) being formatted on the basis on MML (Man-Machine Language) of ITU-T (International Telecommunication Union—Telecommunication) Z.3XX series.

TL1 defines commands for maintenance/management of communication equipments and networks constructed with communication equipments, response messages thereof, rules for composing those commands and response messages and the like. In fact, TL1 is the most popular command for maintenance/management of communication equipment/network not only in the North America but also in the rest of the world. Well-known enterprises using TL1 command line language include ALCATEL, NORTEL, LUCENT, FUJITSU, CIENA, CISCO, NEC and so on.

TL1 has the following benefits.

TL1 is very easy to understand.

Unlike SNMP, which is a Machine-to-Machine Management Protocol, and CMIP (Common Management Information Protocol), TL1 consists of commands and messages in ASCII (American Standard Code for Information Interchange) character string. Since SNMP and CMIP uses Binary encoded format, called ASN.1 (Abstract Syntax Notation #0.1), an ordinary person cannot read it and even when he/she does, there is no way to understand its meaning. TL1, on the other hand, uses ASCII characters, so anyone can read and understand messages without specific knowledge in TL1 grammar.

2. It is possible and easy to mechanically create and interpret commands and messages.

Each command and each message are architecturally structured in block units. Since function and grammar are accurately defined for each block, it is easy to mechanically create and interpret messages. Also, TL1 is easily converted to a binary format for use in Machine-to-Machine communications.

3. Management of automatic report and operational commands is possible.

All automatic report messages, commands, and response messages include a TAG field for management. In case of automatic report messages, an automatic tracking function can be implemented by using an ATAG (Automously correlation TAG), a sequentially increasing counter, which is divided according to kinds of messages (e.g. failure, performance). In case of operational commands, a CTAG (Correlation TAG) is used to provide correlation between commands and response messages.

4. Almost every operational command and message is defined.

Operational commands and messages with different functions (failure, configuration, performance, security etc.) are defined for every possible case. Moreover, parameters and error codes are fully detailed as well. Therefore, when TL1 is applied, a same message can be used for a same function, regardless of kind of equipment, that is, equipment compatibility is provided.

As such, TL1 error cause is easy to use for an operator. In addition, since TL1 defines every error case, if there is any undefined error in SNMP V1/V2/V3, it is informed to a manager via TL1, and the manager is then able to figure out what causes an error more accurately, performing a more accurate analysis and error process.

In general, TL1 error causes are categorized (large categories) as follows.

Each category is divided into sub-error causes (small categories), and each of the small categories was numbered at 200 intervals.

Error objects in relation to equipment ready status are illustrated in Table 2 below.

TABLE 2

| Error causes | Descriptions |
|---|---|
| TL1_EATN = 100 | Equipage, Not Valid for |
| | Access Type |
| TL1_ENAC = 200 | Equipage, Not equipped with |
| | Alarm Cutoff |
| . . . | . . . |
| TL1_ENSS = 3200 | Equipage, Not equipped with Synchronization |
| | Switching |

Error objects in relation to input are illustrated in Table 3 below.

TABLE 3

| Error causes | Descriptions |
|---|---|
| TL1_ICNV = 3400 | Input, Command Not Valid |
| TL1_IDNV = 3600 | Input, Data Not Valid |
| . . . | . . . |
| TL1_ISPC = 5800 | Input, Syntax invalid PunCtuation |

The same numbering system with 200 intervals is applied to error objects in relation to privilege, status, resource, and fault, so no details on this will be provided.

As discussed above, when adding sub-error causes (small categories) given that the sub-error causes are already numbered at 200 intervals, a corresponding object is searched out from the error cause objects (large categories), and a new number is given to the corresponding object (for example, if it is related to ‘Input, Command Not Valid’, choose one of 3401 to 3599).

Supporting error cause of a network management system configured by an SNMP (Simple Network Management Protocol) manager and a SNMP agent can be further clarified by the following. There is a selection of a standard error cause management interface to be used, if an error which is not defined by SNMP error cause occurs. Then, there is a numbering of an error cause defined by the selected interface. The numbered error cause is stored in a database of the SNMP manager database and a database of the SNMP agent, respectively. When the standard error cause is databased, there is actually an exchanging of a message between the SNMP manager and the SNMP agent, and conducting a network management operation.

The TL1 (Transanction Language 1) can be used for the standard error cause interface selected. The error causes can be numbered by categorizing the kinds of error and sub-categorizing already categorized objects additionally, and error objects created when a new error occurs are newly added to corresponding categories. The kinds of error causes maybe numbered at 200 intervals. The standard error cause stored in the databases can be interpreted based on an error status corresponding to a number given by an error analysis application that is installed in the SNMP agent and the SNMP manager. The standard error cause stored in the databases can be represented by a number in an Err-Status (error status) field of SNMP PDU (Protocol Data Unit), in accordance with the kind of error.

Explained now is a method for supporting error cause in network management system that provides error causes by applying TL1.

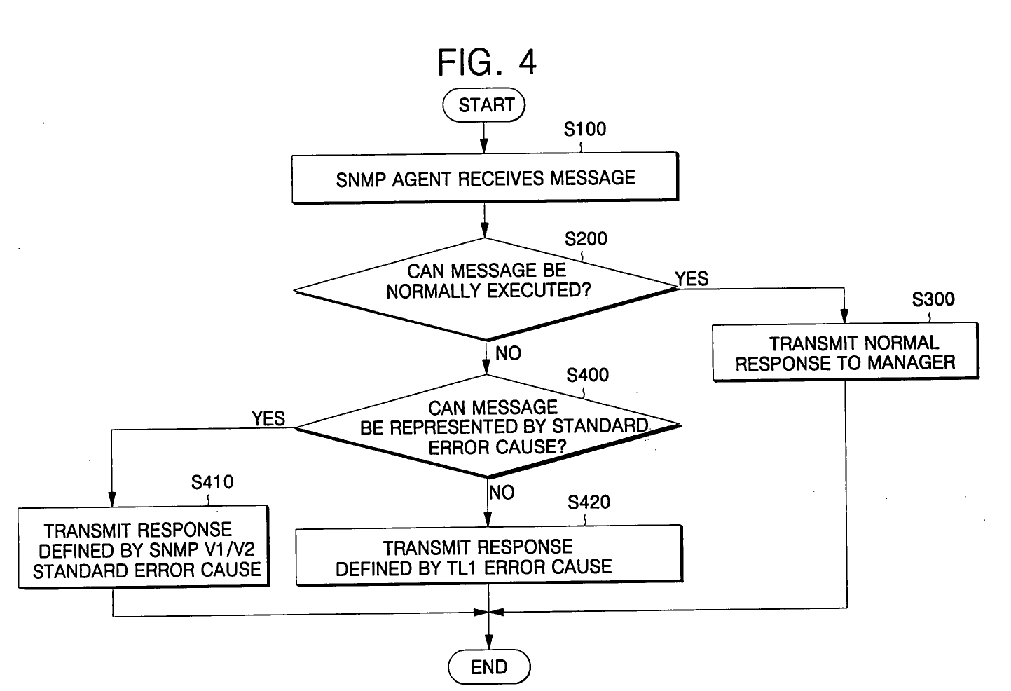

FIG. 4 is a flow chart describing the method for supporting error cause of network management system using SNMP according to a preferred embodiment of the present invention.

Referring to FIG. 4, the SNMP agent 20 receives an SNMP message from the SNMP manager 10 under Get/SetRequest command (S100), and analyzes the received SNMP message to compare and find out whether or not a normal execution is possible (S200).

If it turns out that the normal execution is possible in step 200, the SNMP agent 20 executes an internal command, and transmits a response message thereof to the SNMP manager 10 (S300).

However, if it turns out that the SNMP message is abnormal in step 200, the SNMP agent 20 compares current error status (SNMP message) to error cause stored in a database about SNMP standard error causes. And SNMP agent 20 finds out whether the error status can be represented by one of the error causes stored in the database about SNMP standard error causes (S400).

If the SNMP message can be represented by the error cause stored in the database about SNMP standard error causes in step 400, the response message based on the SNMP standard error causes is transmitted to the SNMP manager 10 (S410).

On the other hand, if it is impossible to express by the error cause stored in the database about SNMP standard error causes in step 400, the SNMP agent 20 transmits the response message using different standard error causes (TL1) stored in a database about different standard error causes (TL1) (S420).

The present invention can be realized as computer-executable instructions in computer-readable media. The computer-readable media includes all possible kinds of media in which computer-readable data is stored or included or can include any type of data that can be read by a computer or a processing unit. The computer-readable media include for example and not limited to storing media, such as magnetic storing media (e.g., ROMs, floppy disks, hard disk, and the like), optical reading media (e.g., CD-ROMs (compact disc-read-only memory), DVDs (digital versatile discs), re-writable versions of the optical discs, and the like), hybrid magnetic optical disks, organic disks, system memory (read-only memory, random access memory), non-volatile memory such as flash memory or any other volatile or non-volatile memory, other semiconductor media, electronic media, electromagnetic media, infrared, and other communication media such as carrier waves (e.g., transmission via the Internet or another computer). Communication media generally embodies computer-readable instructions, data structures, program modules or other data in a modulated signal such as the carrier waves or other transportable mechanism including any information delivery media. Computer-readable media such as communication media may include wireless media such as radio frequency, infrared microwaves, and wired media such as a wired network. Also, the computer-readable media can store and execute computer-readable codes that are distributed in computers connected via a network. The computer readable medium also includes cooperating or interconnected computer readable media that are in the processing system or are distributed among multiple processing systems that maybe local or remote to the processing system. The present invention can include the computer-readable medium having stored thereon a data structure including a plurality of fields containing data representing the techniques of the present invention.

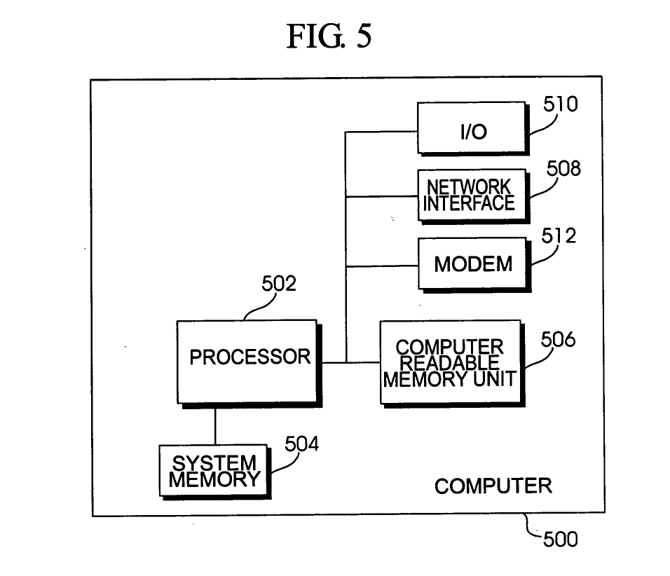

An example of a computer, but not limited to this example of the computer, that can read computer readable media that includes computer-executable instructions of the present invention is shown in FIG. 5. The computer 500 includes a processor 502 that controls the computer 500. The processor 502 uses the system memory 504 and a computer readable memory device 506 that includes certain computer readable recording media. A system bus connects the processor 502 to a network interface 508, modem 512 or other interface that accommodates a connection to another computer or network such as the Internet. The system bus may also include an input and output interface 510 that accommodates connection to a variety of other devices.

In conclusion, the present invention can be advantageously used for preventing error occurrence for the second, third time due to ambiguous error causes, by expressing a status of an SNMP agent more accurately than 20 error causes defined by SNMP V1/V2/V3. In this manner, when an operator does network management, a great amount of time is saved.

Moreover, using error cause categories of a different standard (namely, TL1), it is possible to integrate different error causes by project, applying to the development of an SNMP agent for other equipment later on, and it can be a new standard for defining an SNMP error cause from now on.

While the present invention has been particularly shown and described with reference to exemplary embodiments thereof, it will be understood by those skilled in the art that the foregoing and other changes in form and details may be made therein without departing from the spirit and scope of the invention.

What is claimed is:

1. A method for supporting error cause of network management system configured by a Simple Network Management Protocol manager and a Simple Network Management Protocol agent, the method comprising the steps of:
selecting a standard error cause management interface to be used, when an error not defined by Simple Network Management Protocol error cause occurs;
numbering an error cause defined by the selected interface;
storing the numbered error cause in a database of the Simple Network Management Protocol manager database and a database of the Simple Network Management Protocol agent, respectively; and
when standard error cause is databased, exchanging a message between the Simple Network Management Protocol manager and the Simple Network Management Protocol agent, and conducting a network management operation.

2. The method according to claim 1, wherein Transaction Language 1 is used for the standard error cause interface selected.

3. The method according to claim 1, wherein error causes are numbered by categorizing the kinds of error and sub-categorizing already categorized objects additionally, and error objects created when a new error occurs are newly added to corresponding categories.

4. The method according to claim 1, wherein the kinds of error causes are numbered at 200 intervals.

5. The method according to claim 3, wherein the kinds of error causes are numbered at 200 intervals.

6. The method according to claim 1, wherein the standard error cause stored in the databases is interpreted based on an error status corresponding to a number given by an error analysis application that is installed in the Simple Network Management Protocol agent and the Simple Network Management Protocol manager.

7. The method according to claim 1, wherein the standard error cause stored in the databases is represented by a number in an Err-Status field of Simple Network Management Protocol (SNMP) Protocol Data Unit, in accordance with the kind of an error.

8. The method according to claim 6, wherein the standard error cause stored in the databases is represented by a number in an Err-Status field of Simple Network Management Protocol (SNMP) Protocol Data Unit, in accordance with the kind of an error.

9. The method according to claim 1, wherein the step for exchanging the message between the Simple Network Management Protocol manager and the Simple Network Management Protocol agent and conducting the network management operation comprises sub-steps of:
receiving, at the Simple Network Management Protocol agent, a Simple Network Management Protocol message from the Simple Network Management Protocol manager under Get/SetRequest command;
comparing and deciding, at the Simple Network Management Protocol agent, whether a normal operation on the Simple Network Management Protocol message is possible by analyzing the received Simple Network Management Protocol message;
when the normal operation can be performed, executing, at the Simple Network Management. Protocol agent, an internal command, and transmitting a response message thereof to the Simple Network Management Protocol manager;
when the Simple Network Management Protocol message is abnormal, comparing and deciding, at the Simple Network Management Protocol agent, whether the Simple Network Management Protocol message can be represented by a Simple Network Management Protocol standard error cause;
when the Simple Network Management Protocol message can be represented by the Simple Network Management Protocol standard error cause, transmitting, at the Simple Network Management Protocol agent, the Simple Network Management Protocol manager a response message defined by the Simple Network Management Protocol standard error cause; and
when the Simple Network Management Protocol message cannot be represented by the Simple Network Management Protocol standard error cause, transmitting, at the Simple Network Management Protocol agent, the Simple Network Management Protocol manager a response message based on a different error cause.

10. An apparatus for supporting error cause of network management system configured of a Simple Network Management Protocol manager and a Simple Network Management Protocol agent, the apparatus comprising:
a Simple Network Management Protocol manager mounted with a database for providing Simple Network Management Protocol standard error causes and a database for providing extended standard error causes besides the Simple Network Management Protocol standard error causes by using a different protocol, and an error analysis application for analyzing an extended standard error cause; and
a Simple Network Management Protocol agent mounted with a database for providing Simple Network Management Protocol standard error causes and a database for providing extended standard error causes besides the Simple Network Management Protocol standard error causes by using a different protocol, and an error search application for searching an error cause number in case an error cause corresponding to a present error status is found in the extended standard error causes, and recording the error cause number in an Err-Status field of a Simple Network Management Protocol (SNMP) Protocol Data Unit.

11. A computer-readable medium having computer-executable instructions for performing a method, comprising:
selecting a standard error cause management interface to be used, when an error not defined by Simple Network Management Protocol error cause occurs;
numbering an error cause defined by the selected interface;
storing the numbered error cause in a database of a Simple Network Management Protocol manager database and a database of a Simple Network Management Protocol agent, respectively; and
when standard error cause is databased, exchanging a message between the Simple Network Management Protocol manager and the Simple Network Management Protocol agent, and conducting a network management operation.

12. The computer-readable medium having computer-executable instructions for performing a method according to claim 11, wherein Transaction Language 1 is used for the standard error cause interface selected.

13. The computer-readable medium having computer-executable instructions for performing a method according to claim 11, wherein error causes are numbered by categorizing the kinds of error and sub-categorizing already categorized objects additionally, and error objects created when a new error occurs are newly added to corresponding categories.

14. The computer-readable medium having computer-executable instructions for performing a method according to claim 11, wherein the kinds of error causes are numbered at 200 intervals.

15. The computer-readable medium having computer-executable instructions for performing a method according to claim 11, wherein the standard error cause stored in the databases is interpreted based on an error status corresponding to a number given by an error analysis application that is installed in the Simple Network Management Protocol agent and the Simple Network Management Protocol manager.

16. The computer-readable medium having computer-executable instructions for performing a method according to claim 15, wherein the standard error cause stored in the databases is represented by a number in an error status field of Simple Network Management Protocol (SNMP) Protocol Data Unit, in accordance with the kind of an error.

17. The computer-readable medium having computer-executable instructions for performing a method according to claim 11, wherein the step for exchanging the message between the Simple Network Management Protocol manager and the Simple Network Management Protocol agent and conducting the network management operation comprises sub-steps of:
receiving, at the Simple Network Management Protocol agent, a Simple Network Management Protocol message from the Simple Network Management Protocol manager under Get/SetRequest command;
comparing and deciding, at the Simple Network Management Protocol agent, whether a normal operation on the Simple Network Management Protocol message is possible by analyzing the received Simple Network Management Protocol message;
when the normal operation can be performed, executing, at the Simple Network Management Protocol agent, an internal command, and transmitting a response message thereof to the Simple Network Management Protocol manager;
when the Simple Network Management Protocol message is abnormal, comparing and deciding, at the Simple Network Management Protocol agent, whether the Simple Network Management Protocol message can be represented by a Simple Network Management Protocol standard error cause;
when the Simple Network Management Protocol message can be represented by the Simple Network Management Protocol standard error cause, transmitting, at the Simple Network Management Protocol agent, the Simple Network Management Protocol manager a response message defined by the Simple Network Management Protocol standard error cause; and
when the Simple Network Management Protocol message cannot be represented by the Simple Network Management Protocol standard error cause, transmitting, at the Simple Network Management Protocol agent, the Simple Network Management Protocol manager a response message based on a different error cause.

18. A computer-readable medium having stored thereon a data structure comprising:
a first field containing data representing selecting a standard error cause management interface to be used, when an error not defined by Simple Network Management Protocol error cause occurs;
a second field containing data representing numbering an error cause defined by the selected interface;
a third field containing data representing storing the numbered error cause in a database of the Simple Network Management Protocol manager database and a database of the Simple Network Management Protocol agent, respectively; and
a fourth field containing data representing, when standard error cause is databased, exchanging a message between the Simple Network Management Protocol manager and the Simple Network Management Protocol agent, and conducting a network management operation, Transaction Language 1 is used for the standard error cause interface selected, the error causes are numbered by categorizing the kinds of error and sub-categorizing already categorized objects additionally, and error objects created when a new error occurs are newly added to corresponding categories, the kinds of error causes are numbered at 200 intervals, the standard error cause stored in the databases is interpreted based on an error status corresponding to a number given by an error analysis application that is installed in the Simple Network Management Protocol agent and the Simple Network Management Protocol manager, the standard error cause stored in the databases is represented by a number in an error status field of Simple Network Management Protocol (SNMP) Protocol Data Unit, in accordance with the kind of an error.

19. The computer-readable medium having stored thereon a data structure according to claim 18, with the fourth field further comprising of:
a first sub-field containing data representing receiving, at the Simple Network Management Protocol agent, a Simple Network Management Protocol message from the Simple Network Management Protocol manager under Get/SetRequest command;
a second sub-field containing data representing comparing and deciding, at the Simple Network Management Protocol agent, whether a normal operation on the Simple Network Management Protocol message is possible by analyzing the received Simple Network Management Protocol message;
a third sub-field field containing data representing, when the normal operation can be performed, executing, at the Simple Network Management Protocol agent, an internal command, and transmitting a response message thereof to the Simple Network Management Protocol manager;
a fourth sub-field containing data representing, when the Simple Network Management Protocol message is abnormal, comparing and deciding, at the Simple Network Management Protocol agent, whether the Simple Network Management Protocol message can be represented by a Simple Network Management Protocol standard error cause;
a fifth sub-field containing data representing, when the Simple Network Management Protocol message can be represented by the Simple Network Management Protocol standard error cause, transmitting, at the Simple Network Management Protocol agent, the Simple Network Management Protocol manager a response message defined by the Simple Network Management Protocol standard error cause; and
a sixth sub-field containing data representing, when the Simple Network Management Protocol message cannot be represented by the Simple Network Management Protocol standard error cause, transmitting, at the Simple Network Management Protocol agent, the Simple Network Management Protocol manager a response message based on a different error cause.

20. A method, comprising of:
receiving by an agent of a first protocol, a message of a first protocol from a manager of the first protocol;
determining by the agent, whether the received message can be normally executed;
when normal execution of the received message is determined, executing an internal command in the agent and transmitting a response message to the manager;
when abnormal execution of the received message is determined, determining by the agent, whether the abnormal received message can be represented by one of a standard error causes of the first protocol;
when it is determined that the received message can be represented by at least one of the standard error causes of the first protocol, transmitting the response message based on the standard error causes to the manager;
when it is determined that the received message is impossible to be expressed as at least one of the standard error causes, transmitting by the agent, the response message using different standard error causes.

21. The method of claim 20, with the different standard error causes belonging to a second protocol.

22. The method of claim 21, with the first protocol being Simple Network Management Protocol.

23. The method of claim 22, with the second protocol being Transaction Language 1.
